(19) United States
(12) Patent Application Publication
(10) Pub. No.: US 2026/0154850 A1
(43) Pub. Date: Jun. 4, 2026

(54) METHOD, APPARATUS, AND MEDIUM FOR POINT CLOUD CODING

(71) Applicants: Beijing Bytedance Network Technology Co., Ltd., Beijing (CN); Bytedance Inc., Los Angeles, CA (US)

(72) Inventors: Yingzhan XU, Beijing (CN); Kai ZHANG, Los Angeles, CA (US); Li ZHANG, Los Angeles, CA (US)

(21) Appl. No.: 19/177,461

(22) Filed: Apr. 11, 2025

Related U.S. Application Data
(63) Continuation of application No. PCT/CN2023/088479, filed on Apr. 14, 2023.

(30) Foreign Application Priority Data
Oct. 13, 2022 (WO) PCT/CN2022/125214

(51) Int. Cl. G06T 9/00

(52) U.S. Cl. CPC G06T 9/00

(57) ABSTRACT

Embodiments of the present disclosure provide a solution for point cloud coding. A method for point cloud coding is proposed. The method comprises: obtaining, for a conversion between a current point cloud (PC) sample of a point cloud sequence and a bitstream of the point cloud sequence, a first indication indicating whether a multi-reference inter prediction in which a plurality of reference PC samples are used is enabled for the point cloud sequence; and performing the conversion based on the first indication.

### CROSS REFERENCE TO RELATED APPLICATIONS

This application is a continuation of International Application No. PCT/CN2023/088479, filed on Apr. 14, 2023, which claims the benefit of International Application No. PCT/CN2022/125214, filed on Oct. 13, 2022. The entire contents of these applications are hereby incorporated by reference in their entireties.

### FIELDS

Embodiments of the present disclosure relates generally to point cloud coding techniques, and more particularly, to multi-reference inter prediction for point cloud coding.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding quality of conventional point cloud coding techniques is generally expected to be further improved.

### SUMMARY

Embodiments of the present disclosure provide a solution for point cloud coding.

In a first aspect, a method for point cloud coding is proposed. The method comprises: obtaining, for a conversion between a current point cloud (PC) sample of a point cloud sequence and a bitstream of the point cloud sequence, a first indication indicating whether a multi-reference inter prediction in which a plurality of reference PC samples are used is enabled for the point cloud sequence; and performing the conversion based on the first indication.

Based on the method in accordance with the first aspect of the present disclosure, the conversion between the point cloud sequence and the bitstream is performed based on an indication indicating whether the multi-reference inter prediction is enabled for the point cloud sequence. Thereby, the proposed method can advantageously facilitate the application of multi-reference inter prediction, and thus the coding quality of point cloud coding can be improved.

In a second aspect, an apparatus for point cloud coding is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a point cloud sequence which is generated by a method performed by an apparatus for point cloud coding. The method comprises: obtaining a first indication indicating whether a multi-reference inter prediction in which a plurality of reference PC samples are used is enabled for the point cloud sequence; and generating the bitstream based on the first indication.

In a fifth aspect, a method for storing a bitstream of a point cloud sequence is proposed. The method comprises: obtaining a first indication indicating whether a multi-reference inter prediction in which a plurality of reference PC samples are used is enabled for the point cloud sequence; generating the bitstream based on the first indication; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a block diagram that illustrates an example point cloud coding system that may utilize the techniques of the present disclosure;

FIG. 2 illustrates a block diagram that illustrates an example point cloud encoder, in accordance with some embodiments of the present disclosure;

FIG. 3 illustrates a block diagram that illustrates an example point cloud decoder, in accordance with some embodiments of the present disclosure;

FIG. 4 illustrates a schematic diagram illustrates an example of inter prediction for predictive geometry coding;

FIG. 5 illustrates a schematic diagram illustrates an example of group of frame (GOF) structure with a GOF size of 8;

FIG. 6 illustrates a schematic diagram illustrates an example of hierarchical reference relationship of one GOF;

FIG. 7 illustrates a schematic diagram illustrates another example of hierarchical reference relationship of one GOF;

FIG. 8 illustrates a schematic diagram illustrates an example of deriving a prediction direction of child nodes;

FIG. 9 illustrates a schematic diagram illustrates an example of reference relationship of one IPPP GOF structure;

FIG. 10 illustrates a flowchart of a method for point cloud coding in accordance with some embodiments of the present disclosure; and

FIG. 11 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

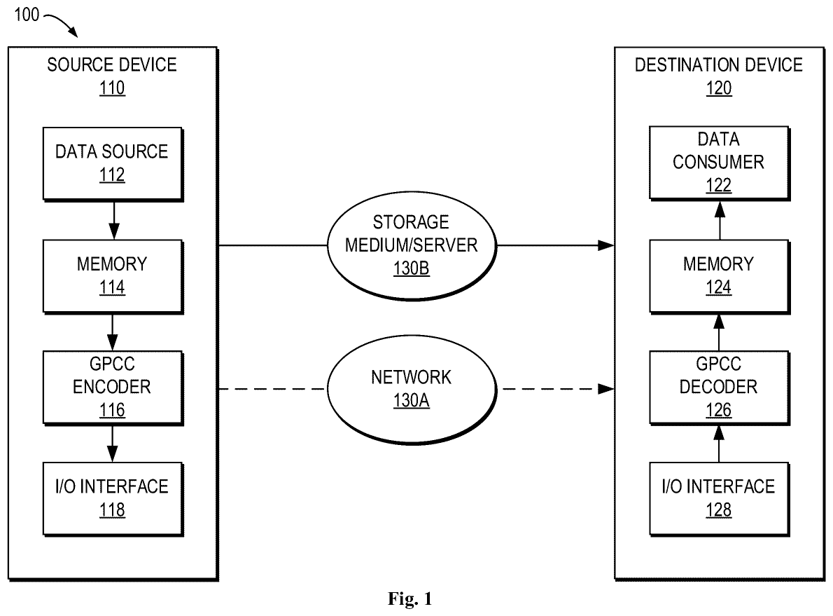

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110.

The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

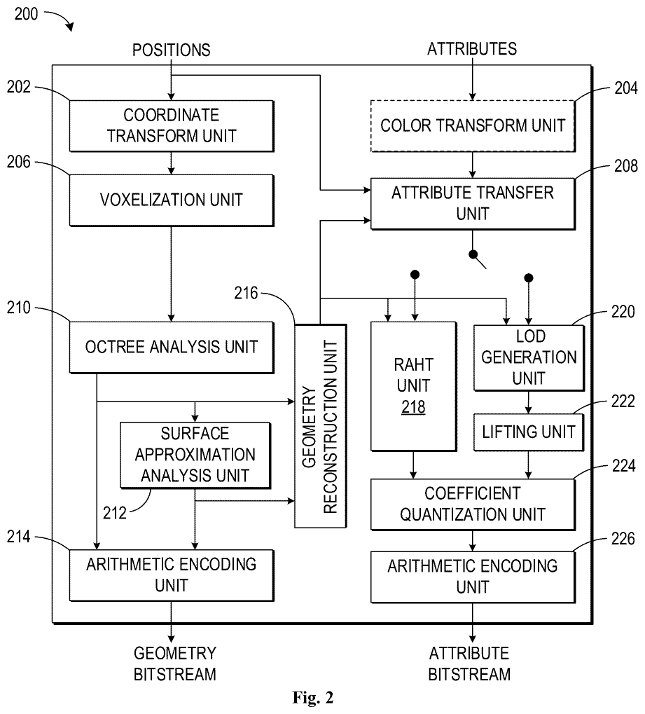

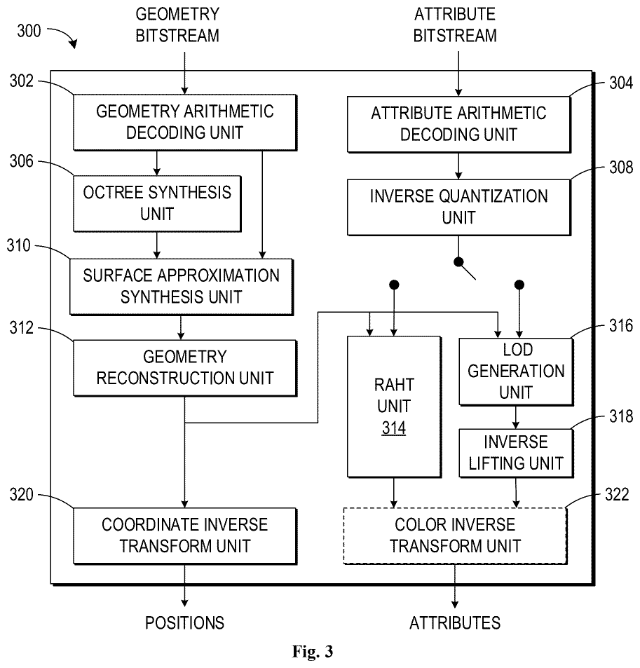

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. Brief Summary

This disclosure is related to point cloud coding technologies. Specifically, it is about coding and encapsulation of coding parameters in point cloud coding. The ideas may be applied individually or in various combination, to any point cloud coding standard or non-standard point cloud codec, e.g., the being-developed Geometry based Point Cloud Compression (G-PCC).

### 2. Abbreviations

G-PCC Geometry based Point Cloud Compression
MPEG Moving Picture Experts Group
3DG 3D Graphics Coding Group
CFP Call for Proposal
V-PCC Video-based Point Cloud Compression
CE Core Experiment
EE Exploration Experiment
inter-EM inter Exploration Model
GOF Group of Frame
RDO Rate Distortion Optimization
GM Global Motion
QP Quantization Parameter
RA Random Access
FIFO First In First Out
OC Occupancy Code
POC Picture Order Count
PC Point Cloud

### 3. Introduction

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions.

To explore the future point cloud coding technologies in G-PCC, Core Experiment (CE) 13.5 and Exploration Experiment (EE) 13.2 were formed to develop inter prediction technologies in G-PCC. Since then, many new inter prediction methods have been adopted by MPEG and put into the reference software named inter Exploration Model (inter-EM).

In one point cloud frame, there are many data points to describe the 3D objects or scenes. For each data point, there may be corresponding geometry information and attribute information. Geometry information is used to record the spatial location of the data point. Attribute information is used to record more details of the data point, such as texture, normal vector and reflection. In inter-EM, there are some optional tools to support the inter prediction coding and decoding of geometry information and attribute information respectively.

For attribute information, the codec uses the attribute information of the reference points to perform the inter prediction for each point in current frame. The reference points are selected from the data points in current frame and reference frame based on the geometric distance of points. Each reference point corresponds to one weight value which is based on the geometric distance from the current point. The predicted attribute value can be the weighted average value of or one of the attribute values of the reference points. The decision on predicted attribute value is based on Rate Distortion Optimization (RDO) methods.

For geometry information, there are two main methods to perform the inter prediction coding, which are octree based method and predictive tree based method.

In the first method, the geometry information is represented by octree structures and the occupancy code (OC) of each node. For each node in the octree of the current frame, the codec will decide whether to perform octagonal division or not based on the number of points in the current node. The same division will be performed on the corresponding reference node in the reference frame. At the same time, the occupancy codes of the current node and the reference node will be calculated. The codec will use the occupancy code of the reference node to perform the prediction coding for the occupancy code of the current node.

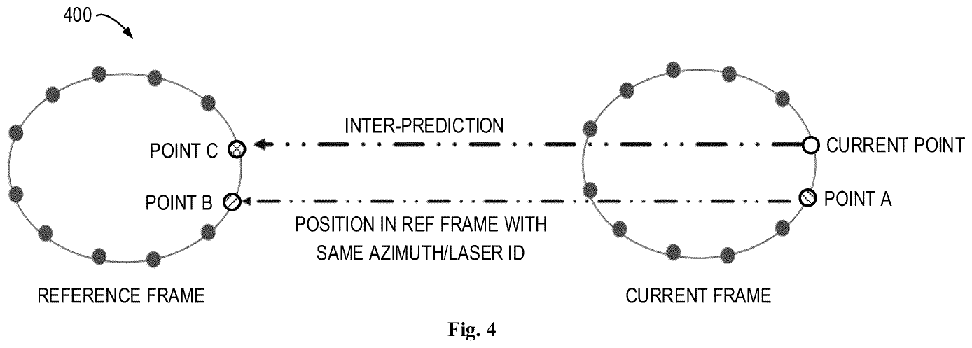

In the second method, the points in the point cloud are sorted to form a predictive tree. As shown in FIG. 4, for each point, the previous decoded point will be chosen as point A. Then the point in the reference frame with the same scaled azimuth and laser ID as point A will be selected as point B. At last, the point in the reference frame which is the first point that has scaled azimuth greater than that of point B will be chosen as point C. The codec will use the geometry information of the point C to perform the prediction coding for the geometry information of the current point.

In current inter-EM, the IPPP structure is applied which means that the reference frame of the current frame is the previous frame if the current frame applies inter prediction. At the same time, inter-EM uses quantization parameters (QP) to control the bit rate points and all frames share the same QP values.

### 4. Problems

The existing designs for inter prediction for point cloud compression have the following problems:
1. In current inter-EM, there is only one reference frame for each frame to perform inter prediction. In theory, the more reference information, the more accurate the prediction results. Using one only reference frame will limit the prediction accuracy and affect the coding efficient.
2. In current inter-EM, the reference frame can only be the frame with the earlier time stamp (i.e., smaller POC values). The purpose of inter prediction is to eliminate redundant information between consecutive frames. However, the redundant information exists not only between the previous frames and the current frame, but also exists between the current frame and the following frames. Only using the frames with earlier time stamps will limit the coding performance.
3. In current inter-EM, the QP value for each frame is the same. However, some frames are the reference frames of other frames, which means the coding priority of them should be higher. In the case of limited transmission resources, they should be assigned a lower QP value to ensure that they can be transmitted more accurately. Applying the same coding accuracy for all frames will affect the coding performance when the transmission resources are very limited.

### 5. Detailed Solutions

To solve the above problems and some other problems not mentioned, methods as summarized below are disclosed. The solutions should be considered as examples to explain the general concepts and should not be interpreted in a narrow way. Furthermore, these solutions can be applied individually or combined in any manner.

In the following discussions, the term “PC sample” refer to the unit that performs prediction coding in the point cloud sequence coding, such as frame/picture/slice/tile/subpicture/node/point/other units that contains one or more nodes or points.
1) It is proposed to divide the frames into one or multiple groups of frames (GOF) in one point cloud sequence to perform point cloud compression.
   a. In one example, N consecutive frames in time stamp order may be clustered as one GOF.
      i. In one example, each frame may belong to one GOF.
      ii. In one example, N may be equal to the GOF size.
   b. In one example, the first frame of a GOF in decoding order may be an I-frame.
      i. In one example, there may be only intra prediction for I-frame.
   c. In one example, the first frame of a GOF in decoding order may not be an I-frame.
      i. In one example, the first frame of a GOF in decoding order may be a P-frame.
      ii. In one example, the first frame of a GOF in decoding order may be a P-frame or a B frame with all reference frames ahead of the current frame in the time stamp order.
   d. Whether to code the first frame of a GOF in decoding order with I-frame may depend on the intra period/random access period.
   e. In one example, the GOF size may be equal to the intra period/random access period.
   f. In one example, the GOF size may be smaller than the intra period/random access period.
   g. In one example, indication of the GOF size and/or coding structure within a GOF may be signalled.
2) It is proposed to use one or multiple reference PC samples to perform the inter prediction for a current PC sample,
   a. In one example, there may be one or multiple reference PC samples for a current PC sample.
   b. In one example, the multiple reference PC samples may be from different reference slices/frames.
      i. Alternatively, the multiple reference PC samples may be from a same reference slices/frame.
   c. In one example, one reference PC samples may be derived from at least one PC reconstructed sample.
      i. In one example, one reference PC sample may be one PC reconstructed sample.
      ii. In one example, one reference PC sample may be the result of a procedure applied on at least one PC reconstructed sample. E.g., the procedure may be sampling or up-sampling.
      iii. In one example, one reference PC sample may be the merged PC sample from multiple PC samples.
         (1) In one example, the merged PC sample of multiple PC samples may be the cluster of all points in the PC samples.
         (2) Alternatively, the merged PC sample of multiple PC samples may be the cluster of partial points in the PC samples,
         a) In one example, the partial points are generated by down-sampling process.
      iv. In one example, one reference PC samples may be the result of a procedure applied on at least one merged sample from multiple PC reconstructed samples. E.g., the procedure may be such as sampling or up-sampling.
   d. In one example, the reference PC sample may be from the same slices/frames as the current PC sample.
   e. Alternatively, furthermore, indication of whether to use multiple reference PC samples may be signalled to the decoder.
   f. In one example, the reference information of a current PC sample (e.g., where the reference PC samples are from and/or which reference PC sample to be used) may be derived at the decoder.
   g. In one example, the reference information of a current PC sample (e.g., where the reference PC samples are from and/or which reference PC sample to be used) may be signalled to the decoder.
      i. In one example, the reference direction may be signaled.
         (1) In one example, the reference direction may include:
         a) The reference direction may be uni-prediction from a reference frame in a first reference list (denoted as L0).
         b) The reference direction may be uni-prediction from a reference frame in a second reference list (denoted as L1).
         c) The reference direction may be bi-prediction (a first reference frame in L0 and a second reference frame in L1).
         (2) In one example, the relative positions of reference frames in reference list may be fixed for a specific frame within one GOF.
         a) In one example, the previously coded N (e.g., N=2) frames in displayer order may be utilized as reference frames.
         i. Alternatively, furthermore, indication of N may be signalled.
         ii. Alternatively, furthermore, the N frames are consecutively previously coded frames right before the specific current frame.
         b) In one example, the relative positions of reference frames in reference lists may be adaptive for a specific frame in a GOF. For example, the positions may be derived based on the GOF size.
         (3) In one example, the reference direction may be conditionally signalled, e.g., according to reference picture list information.
      ii. In one example, indication of the reference frame where the reference PC samples are from may be signaled.
         (1) Indication of the reference frame may be signaled as a reference list index (L0 or L1) and a reference frame index in the reference list.
         a) Alternatively, it may be signalled by reference direction and reference frame index for each direction, if needed.
         (2) The reference list index may be conditionally signaled.
         a) Signaling of the reference list index may be skipped if there is only one reference list.
         (3) The reference frame index for a reference list may be conditionally signaled.
         a) Signaling of the reference frame index may be skipped if there is only one reference frame in the reference list.
      iii. Alternatively, furthermore, indication of the number of reference PC samples may be signalled to the decoder.
      iv. Furthermore, for a sample, at least one indication referring to at least one reference PC sample may be signalled to the decoder to indicate the reference relationship.
         (1) The indication may be conditionally signalled, e.g., depending on whether to use other samples rather than the previous one sample as the reference PC samples.
         (2) The indication may be represented by some indices (e.g., sample id) which indicated the associated sample to be used as the reference PC samples.
         (3) The indication may be coded with fixed-length coding, unary coding, truncated unary coding, etc. al.
         (4) The indication may be coded in a predictive way.
      v. In one example, at least one reference sample.
   h. In one example, the geometry information of the reference PC samples may be used to perform the geometry inter prediction for the current PC sample.
      i. In one example, the geometry information of the reference PC samples may be used to derive the predicted geometry value of the current PC sample.
         (1) In one example, the predicted geometry value may be selected from some candidate predictors.
         a) A candidate predictor may be derived by one or multiple geometry values of the reference samples.
         b) A candidate predictor may be derived as a function of one or multiple geometry values of the reference PC samples.
         c) A candidate predictor may be derived by one or multiple predicted geometry values of the current PC sample or previous decoded samples.
         d) A candidate predictor may be derived as a function of one or multiple predicted geometry values of the current PC sample or previous decoded samples.
         (2) In one example, the candidate predictors may include but not limit to the average value, the weighted average value, one of the geometry information of the reference PC samples, etc. al.
         (3) In one example, the selection of the predictors may be based on rate optimization method, distortion optimization method, RDO method, etc. al.
         (4) In one example, the selection may be derived at the decoder.
         (5) In one example, for each sample, the indication referring to the selected predictor may be signalled to the decoder.
         a) The indication may be coded with fixed-length coding, unary coding, truncated unary coding, etc. al.
         b) The indication may be coded in a predictive way.
         (6) In one example, the residual between the predicted geometry information and real geometry information may be derived and signalled to the decoder.
         a) The residual may be coded with fixed-length coding, unary coding, truncated unary coding, etc. al.
         b) The residual may be coded in a predictive way.
      ii. In one example, the geometry information of the reference PC samples may be used as the contextual information for the predictive coding of the geometry information of the current node.
   i. In one example, the attribute information of the reference PC samples may be used to perform the attribute inter prediction for the current PC sample.
      i. In one example, the attribute information of the reference PC samples may be used to derive the predicted attribute value of the current PC sample.
         (1) In one example, the predicted attribute value may be selected from some candidate predictors.
         a) A candidate predictor may be derived by one or multiple attribute values of the reference PC samples.
         b) A candidate predictor may be derived as a function of one or multiple attribute values of the reference PC samples.
         c) A candidate predictor may be derived by one or multiple predicted attribute values of the current PC sample or previous decoded samples.
         d) A candidate predictor may be derived as a function of one or multiple predicted attribute values of the current PC sample or previous decoded samples.
         (2) In one example, the candidate predictors may include but not limit to the average value, the weighted average value, one of the attribute information of the reference PC samples, etc. al.
         (3) In one example, the selection of the predictors may be based on rate optimization method, distortion optimization method, RDO method, etc. al.
         (4) In one example, the selection may be derived at the decoder.
         (5) In one example, for each sample, the indication referring to the selected predictor may be signalled to the decoder.
         a) The indication may be coded with fixed-length coding, unary coding, truncated unary coding, etc. al.
         b) The indication may be coded in a predictive way.
         (6) In one example, the residual between the predicted attribute information and real attribute information may be derived and signalled to the decoder.
         a) The residual may be coded with fixed-length coding, unary coding, truncated unary coding, etc. al.
         b) The residual may be coded in a predictive way.
      ii. In one example, the attribute information of the reference PC samples may be used as the contextual information for the predictive coding of the attribute information of the current node.
3) It is proposed to use at least one indication to indicate whether the method using multiple reference PC samples is enabled for one point cloud sequence.
   a. In one example, the indication may be signalled to the decoder.
      i. The indication may be coded with fixed-length coding, unary coding, truncated unary coding, etc. al.
      ii. The indication may be coded in a predictive way.
   b. In one example, at most one reference PC sample may be used for inter-frame prediction for one PC sample if the method using multiple reference PC samples is disabled for the point cloud sequence.
4) It is proposed to use at least one indication for each PC sample to indicate whether the multiple reference PC samples are used for inter-frame prediction for the current PC sample,
   a. In one example, the indication may be derived at the encoder.
   b. In one example, the indication may be derived at the decoder.
   c. In one example, the indication may be signalled to the decoder.
      i. The indication may be coded with fixed-length coding, unary coding, truncated unary coding, etc. al.
      ii. The indication may be coded in a predictive way.
5) It is proposed to use at least one kind of GOF structure in one point cloud sequence.
   a. In one example, the frames in different GOF structures may have different reference relationships.
      i. In one example, the frames in IPPP GOF structure may only have the previous one frame as the reference frame, except the first frame.
      ii. In one example, the frames in IBBB GOF structure may have two reference frames, except the first frame.
   b. In one example, one GOF structure may be applied to all GOFs in one point cloud sequence.
   c. In one example, multiple GOF structures may be applied to the GOFs in one point cloud sequence.
   d. In one example, there may be at least one indication to indicate whether only one GOF structure is applied to all GOFs in one point cloud sequence.
      i. In one example, the indication may be signalled to the decoder.
         (1) The indication may be coded with fixed-length coding, unary coding, truncated unary coding, etc. al.
         (2) The indication may be coded in a predictive way.
   e. In one example, there may be at least one indication to indicate which GOF structure is applied if only one GOF structure is applied to all GOFs in one point cloud sequence.
      i. In one example, the indication may be signalled to the decoder.
         (1) The indication may be coded with fixed-length coding, unary coding, truncated unary coding, etc. al.
         (2) The indication may be coded in a predictive way.
   f. In one example, the GOF motion information may be used to decide which GOF structure is applied to one GOF.
      i. In one example, the GOF motion information may be derived at the encoder.
         (1) In one example, the GOF motion information may be the motion information between the first frame in the GOF and the first frame in the next GOF.
         (2) Alternatively, the GOF motion information may be the motion information between the first frame in the GOF and the last frame in the GOF.
         (3) Alternatively, the GOF motion information may be the motion information between the first I-frame in the GOF and the next I-frame.
      ii. In one example, the IBBB GOF structure is decided to be applied to one GOF only if the GOF motion information meets the GOF constrain condition. Otherwise, the IPPP GOF structure is decided to be applied to the GOF.
         (1) In one example, the GOF motion condition may be that the GOF motion information is less than at least one threshold.
         a) In one example, the thresholds may be derived at the encoder.
         b) In one example, the thresholds may be pre-defined.
      iii. In one example, the decision may be made at the encoder.
      iv. In one example, the decision may be made at the decoder.
   g. In one example, there may be at least one indication for one GOF to indicate which GOF structure is applied to the GOF if multiple GOF structures are applied to the GOFs in one point cloud sequence.
      i. In one example, the indication may be signalled to the decoder.
         (1) The indication may be coded with fixed-length coding, unary coding, truncated unary coding, etc. al.
         (2) The indication may be coded in a predictive way.
   h. In the above description, frame may be replaced by slice/block or other process units.
6) In one example, the information about how to manage decoded frames may be signaled for a frame in point cloud coding.
   a. In one example, a decoded frame may be identified by an index counted in the displaying order.
   b. In one example, a decoded frame may be identified by an index counted in the coding/decoding order.
   c. In one example, which decoded frame(s) should be kept in the frame buffer may be signaled.
   d. In one example, which decoded frame(s) should be removed from the frame buffer may be signaled.
   e. In one example, which decoded frame(s) should be used as a reference frame for a specific frame may be signaled.
   f. In one example, which decoded frame(s) should be put into which reference list may be signaled.
   g. In one example, the order of reference frames may be signaled.
   h. In one example, the information may be signaled associated with a frame.
   i. In one example, the information may be signaled independent of a frame.
7) The sample in a frame with a later time stamp may be used as the reference PC sample for the current PC sample,
   a. In one example, there is time stamp information for each frame in one timed point cloud sequence.
   b. In one example, the time stamp order may be the same as the displaying order.
   c. In one example, the time stamp order may be the same as the rendering order.
   d. In one example, the time stamp of each sample is equal to the time stamp of the frame it belonging to.
   e. In one example, the sample with an earlier time stamp may be used as the reference PC sample for the current PC sample.
   f. In one example, the sample with the same time stamp may be used as the reference PC sample for the current PC sample.
   g. In one example, the sample with a later time stamp may be used as the reference PC sample for the current PC sample.
   h. Alternatively, furthermore, indication of whether to allow using the sample with a later time stamp as the reference PC sample may be signalled to the decoder.
8) In one example, there may be a low-delay mode for point cloud compression.
   a. Alternatively, furthermore, with the low-delay mode, the time stamp order and the decoding order must be the same.
   b. Alternatively, furthermore, indication of whether to use low-delay mode may be signalled to the decoder.
   c. Alternatively, furthermore, multiple reference frames may be used for the low-delay mode.
9) It is proposed to use the sample in the frame with an earlier time stamp or the same time stamp as the reference sample in low delay mode.
   a. In one example, the sample with an earlier time stamp may be used as the reference PC sample for the current PC sample in low delay mode.
   b. In one example, the sample with the same time stamp may be used as the reference PC sample for the current PC sample in low delay mode.
10) It is proposed to perform the encoding and decoding process based on the reference relationship but not the time stamp order of samples,
   a. In one example, the reference PC samples may be encoded before the current PC sample.
   b. In one example, the reference PC samples may be decoded before the current PC sample.
11) In one example, the time stamp order of each PC sample may be signalled to the decoder.
   a. In one example, the time stamp order of each PC sample may be different with the coding/decoding order of each PC sample.
   b. In one example, the time stamp order may be in the form of continuously increasing integer numbers.
   c. In one example, the time stamp order may be directly signalled to the decoder.
      i. The time stamp order may be coded with fixed-length coding, unary coding, truncated unary coding, etc. al.
      ii. The time stamp order may be coded in a predictive way.
   d. In one example, the time stamp order may be indirectly signalled to the decoder.
      i. In one example, the relative time stamp order may be derived at the encoder.
         (1) In one example, the relative time stamp order of one PC sample may be derived based on the time stamp order of the current PC sample and the time stamp order of another specific PC sample.
         (2) In one example, the specific PC sample may be before the current PC sample in encoding/decoding order.
         (3) In one example, the specific PC sample may be the previous one PC sample in encoding/decoding order.
         (4) In one example, the specific PC sample may be the previous one PC sample that satisfies certain characteristics in encoding/decoding order.
         a) In one example, the specific PC sample may be the previous PC sample where the inter prediction is disabled.
         b) In one example, the specific PC sample may be the previous PC sample where only one reference PC sample is used in inter prediction.
      ii. In one example, the relative time stamp order may be signalled to the decoder.
         (1) The relative time stamp order may be coded with fixed-length coding, unary coding, truncated unary coding, etc. al.
         (2) The relative time stamp order may be coded in a predictive way.
      iii. In one example, the time stamp order may be derived based on the relative time stamp order at the decoder.
12) For an inter-coded slice/frame wherein inter prediction is enabled, the information of reference frames may be signaled.
   a. The information of reference frames may comprise,
      i. Number of reference frames.
      ii. Number of reference lists.
      iii. Number of reference frames in each reference list.
      iv. Reference frames in each reference list.
         (1) A reference frame may be indicated by its time stamp or POC or other ways.
   b. The information may be shared by multiple frames, such as signalled in a higher-level syntax structure (e.g., in SPS/PPS).
13) It is proposed to code PC samples in different orders instead of being in a fixed order and/or different coding accuracies of PC samples,
   a. In one example, it is proposed to apply hierarchical coding accuracy based on the coding priorities of the PC samples.
      i. In one example, the PC samples may have different coding priorities in one point cloud sequence.
   b. In one example, the coding priority of the reference PC sample should be higher than the current PC sample.
   c. In one example, the coding accuracy of the sample with higher coding priority should be higher than the sample with lower coding priority.
   d. In one example, the coding accuracy may be controlled be the QP value/quantization step in point cloud sequence coding.
   e. In one example, the QP/quantization step value for the reference PC sample may be lower/smaller than the current PC sample.
   f. In one example, the delta value of the QP/quantization step value for the reference PC sample may be fixed.
   g. In one example, the delta value of the QP/quantization step value for the reference PC sample may be derived at the decoder.
      i. In one example, the delta value of the QP/quantization step value for the reference PC sample may be derived based on the GOF size.
      ii. In one example, the delta value of the QP/quantization step value for the reference PC sample may be derived based on the intra period/random access period.
      iii. In one example, the delta value of the QP/quantization step value for the reference PC sample may be derived based on the indicators of lossless coding mode.
      iv. In one example, the delta value of the QP/quantization step value for the reference PC sample may be derived based on the indicators of low delay coding mode.
   h. In one example, the delta value of the QP/quantization step value for the reference PC sample may be signalled to the decoder.
   i. In above examples, the “reference PC sample” may be replaced by “current PC sample”.
   j. Alternatively, furthermore, indication of whether to use hierarchical QP values and/or QP values/quantization steps may be signalled to the decoder.
   k. In one example, the QP value for each sample may be derived at the decoder.
14) In one example, the QP value for each frame/block/cube/tile/slice may be signalled to the decoder.
   a. The QP value may be coded with fixed-length coding, unary coding, truncated unary coding, etc. al.
   b. The QP value may be coded in a predictive way.
15) It is proposed to use the occupancy information of multiple reference nodes to perform the inter prediction for the current node when using octree geometry coding.
   a. In one example, the geometry information may be represented by the octree structure and the occupancy information (such as occupancy code) of octree nodes when using octree geometry coding.
   b. In one example, for each frame, there may be multiple reference frames.
   c. Alternatively, furthermore, indication of whether to use multiple reference frames may be signalled to the decoder.
   d. In one example, for each node, there may be at least one corresponding reference node in each reference frame.
   e. In one example, for each node, the reference occupancy code may be selected from some candidate values.
      i. A candidate value may be derived by the occupancy information of one or multiple reference nodes.
      ii. A candidate value may be derived as a function of the occupancy information of one or multiple reference nodes.
      iii. In one example, the candidate values may include but not limit to the XOR, same or, one of the occupancy information of the reference nodes.
      iv. In one example, the selection of the candidate values may be based on rate optimization method, distortion optimization method, RDO method, etc. al.
      v. In one example, the selection may be derived at the decoder.
      vi. In one example, the indication referring to the selected candidate value may be signalled to the decoder.
         (1) The indication may be coded with fixed-length coding, unary coding, truncated unary coding, etc. al.
         (2) The indication may be coded in a predictive way.
   f. In one example, for each node, the reference occupancy code may be used as the predicted occupancy information.
      i. Furthermore, the residual between the predicted occupancy information and the real occupancy information may be derived and signalled to the decoder.
         (1) The residual may be coded with fixed-length coding, unary coding, truncated unary coding, etc. al.
         (2) The residual may be coded in a predictive way.
   g. In one example, for each node, the reference occupancy information may be used as the contextual information for the predictive coding of the occupancy information of the current node.
16) It is proposed to derive the selections of reference occupancy information for the child nodes based on the current node and reference nodes of the current nodes when using octree geometry coding.
   a. In one example, the geometry information may be represented by the octree structure and the occupancy information (such as occupancy code) of octree nodes when using octree geometry coding.
   b. In one example, for each node, there may be one occupancy code, which is an 8-bit binary number. Each bit corresponds to one child node.
   c. In one example, for each node, there may be multiple reference nodes and corresponding occupancy codes.
   d. In one example, for each node, there may be one reference occupancy code.
   e. In one example, for each node, the reference occupancy code may be selected from one of occupancy codes of the reference nodes.
   f. In one example, for each node, the selection of reference occupancy code of the child nodes may be derived based on the occupancy codes of the current node and the reference nodes of the current node.
      i. In one example, for each bit in the occupancy codes of the current node and the reference nodes of the current node:
         (1) If the bit values are the same at the same bit location for current node and one reference node, the occupancy code of the child node of the reference node may be selected as the reference occupancy code of the child node of the current node. The child node corresponds to the bit location.
      ii. In one example, the numbers of the mismatched bits between the occupancy codes of the current node and the reference nodes of the current nodes are calculated:
         (1) If the numbers of the mismatched bits are the same for all reference nodes, the selection of child node may inherit the selection of the current node.
         (2) If the numbers of the mismatched bits are not same for all reference nodes, the occupancy code of the child node of the reference node, which has the least mismatching number, may be selected as the reference occupancy code of the child node.
17) It is proposed to derive a cumulative global motion based on at least one external estimated global frame for at least one frame.
   a. In one example, the global motion between a frame and its succeeding frame may be estimated externally.
      i. In one example, the global motion may be estimated before the point cloud compression as preprocessing.
      ii. In one example, the global motion may be part of raw data.
   b. In one example, the externally estimated global motion may be used in the global motion estimation.
   c. In one example, the cumulative global motion may be used in place of the externally estimated global motion when the frame distance between the current frame and the reference frame is bigger than a threshold such as 1.
   d. In one example, the cumulative global motion may be derived at the encoder.
   e. In one example, the cumulative global motion between the reference frame and the current frame may be derived based on the externally estimated global motions of the reference frame and the consecutive frames before the current frame in time stamp order.
   f. In one example, the cumulative global motion between the reference frame and the current frame may be derived based on the externally estimated global motions of the current frame and one or multiple consecutive frames before the reference frame in time stamp order.
   g. In one example, the cumulative global motion may be signalled to the decoder.
      i. The cumulative global motion may be coded with fixed-length coding, unary coding, truncated unary coding, etc. al.
      ii. The cumulative global motion may be coded in a predictive way.
      iii. The cumulative global motion may be coded by context coding.
      iv. The cumulative global motion may be coded by by-pass coding.
18) It is proposed to derive the attribute inter thresholds based on the frame distance of at least one reference frame.
   a. In one example, for a reference frame, there may be at least one attribute inter thresholds to decide whether the attribute inter prediction is applied to the reference frame.
   b. In one example, for a reference frame, the attribute inter thresholds may be derived based on the original attribute inter threshold and frame distances of the reference frame.
   c. In one example, the attribute inter threshold requirement of the reference frame with farther frame distance may be stricter than that of the reference frame with closer frame distance.
      i. In one example, the attribute inter threshold may be the original attribute inter threshold divided by frame distance.
   d. The thresholds may be derived at the decoder or it may be signaled from the encoder to the decoder.
19) It is proposed that the search range for the attribute inter prediction may be based on the reference relationship.
   a. The search range of the sample with multiple reference samples may be smaller than that of the sample with one reference sample.
      i. The search range of the sample with one reference sample may be indicated by an integer number (e.g., N); The search range of the sample with M reference samples may be indicated by a smaller integer number (e.g., N/M).
   b. Alternatively, the search range of the sample with multiple reference samples may be bigger than that of the sample with one reference sample.
   c. Alternatively, the search range of the sample with multiple reference samples may be equal to that of the sample with one reference sample.
   d. Alternatively, the search range may be signaled from the encoder to the decoder.
20) It is proposed to perform geometry inter prediction with one or multiple reference frames on a set of layers of the octree structure.
   a. In one example, the set is the first N layers of the octree structure.
   b. In one example, the set is the last N layers of the octree structure.
   c. In one example, the geometry coding may be performed in octree structure with multiple layers.
   d. In one example, the geometry intra prediction coding may be performed on all layers of the octree structure.
   e. In one example, the geometry inter prediction coding with one reference frame may be performed on all layers of the octree structure.
   f. In one example, the geometry inter prediction coding with multiple reference frames may be performed on the first N layers of the octree structure. N may be one non-negative integer.
      i. In one example, N may be one pre-defined value.
      ii. In one example, N may be derived at the encoder.
         (1) N may be derived based on the node size of each layer.
         (2) N may be derived based on the motion block size.
      iii. In one example, N may be derived at the decoder.
         (1) N may be derived based on the node size of each layer.
         (2) N may be derived based on the motion block size.
      iv. In one example, N may be signalled to the decoder.
         (1) N may be coded with fixed-length coding, unary coding, truncated unary coding, etc. al.
         (2) N may be coded in a predictive way.
21) It is proposed to temporarily record the PC reconstructed sample if the PC reconstructed sample is the reference PC sample for other PC samples.
   a. In one example, one PC sample may be reconstructed at the encoder and/or at the decoder.
   b. In one example, one PC reconstructed sample may be the reference PC sample for other PC samples.
   c. In one example, some memory may be used to record one PC reconstructed sample when other PC samples are processed if the PC reconstructed sample is the reference PC sample for other PC samples.
   d. In one example, the memory to record one PC reconstructed sample may be released if the PC reconstructed sample is not the reference PC sample for any other PC sample.
   e. In one example, for each PC sample, there may be at least one indication to indicate whether the PC sample is the reference PC sample for other PC samples.
      i. In one example, the indication may be one flag to indicate whether the PC sample is the reference PC sample for other PC samples.
         (1) In one example, the flag may be derived at the encoder.
         (2) In one example, the flag may be derived at the decoder.
         (3) Alternatively, the flag may be signalled to the decoder.
      ii. In one example, the indication may be the number of PC samples which use the current PC sample as the reference PC sample.
         (1) In one example, the number may be derived at the encoder.
         (2) In one example, the number may be changed when the other PC samples are coded. For example, the number may be reduced by one after the PC sample is referenced by another PC sample. If the number becomes zero, the memory to record the corresponding PC sample may be released.
         (3) In one example, the number may be derived at the decoder.
         (4) In one example, the number may be signalled to the decoder.
22) It is proposed to select the reference points from different reference PC samples for the current PC point to perform the attribute inter prediction.
   a. In one example, for each point, there may be multiple reference points to perform attribute inter prediction.
   b. In one example, the reference points may be selected from multiple samples based on the geometry distance between the reference point and the current point.
   c. In one example, the attribute information of the reference points may be used to derive the predicted attribute value of the current point.
   d. In one example, the predicted attribute value may be selected from some candidate predictors.
      i. A candidate predictor may be derived by attribute information of reference points from one or multiple reference PC samples.
      ii. A candidate predictor may be derived as a function of attribute information of reference points from one or multiple reference PC samples.
      iii. In one example, the candidate predictors may include but not limit to the average value, the weighted average value, one of the attribute information of the reference points, etc. al.
         (1) In one example, the weight of each reference point may be the geometry distance from the current point.
      iv. In one example, the selection of the predictors may be based on rate optimization method, distortion optimization method, RDO method, etc. al.
      v. In one example, for each point, the indication referring to the selected predictor may be signalled to the decoder.
         (1) The indication may be coded with fixed-length coding, unary coding, truncated unary coding, etc. al.
         (2) The indication may be coded in a predictive way.
   e. In one example, the residual between the predicted attribute value and real attribute value may be derived and signalled to the decoder.
      i. The residual may be coded with fixed-length coding, unary coding, truncated unary coding, etc. al.
      ii. The residual may be coded in a predictive way.
   f. In one example, the predicted attribute value may be used as the contextual information for the predictive coding of the attribute information of the current point.

### 6. Embodiments

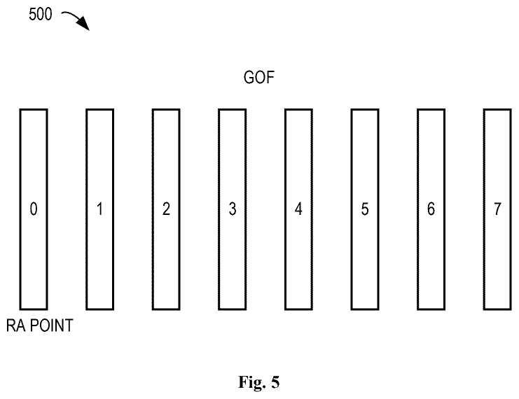

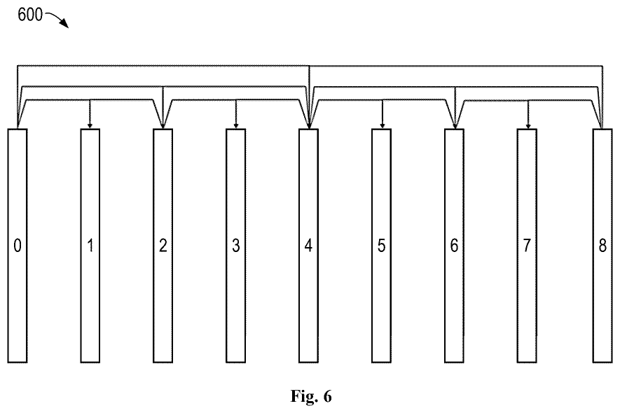

1) This embodiment describes an example of how to use two reference frames and use the frame with later time stamps as reference frames to perform inter prediction for the current frame.
In the example, the point cloud frames in the point cloud sequence are divided in multiple GOFs and the GOF size is set to 8.
As shown in FIG. 5, for each GOF, there are 8 consecutive frames in time stamp order. The numbers in the figure indicate the relative timestamp order of the frames in the GOF. The frame “0” is the first frame in the GOF which means it has the earliest timestamp in the GOF.
The first frame is the random access (RA) point which means that there is only intra prediction coding but no inter prediction coding.
For the other 7 frames, both the intra prediction coding and inter prediction coding will be performed based on the reference relationship.
As shown in FIG. 6, a hierarchical reference relationship is applied for each GOF. In the figure, the frame “8” is the first frame of the next GOF.
For frame “1”˜“7”, each frame has two reference frames. One reference frame has an earlier time stamp than the current frame and another reference frame has a later time stamp than the current frame. For each frame, the reference frames are shown in Table 1.

TABLE 1
Reference frames for each frame in one GOF

| | Frame time stamp | | | | | | | |
|---|---|---|---|---|---|---|---|---|
| | 0 | 1 | 2 | 3 | 4 | 5 | 6 | 7 |
| Reference frame | None | 0, | 0, | 2, | 0, | 4, | 4, | 6, |
| time stamp | | 2 | 4 | 4 | 8 | 6 | 8 | 8 |

To make sure that the reference frames are encoded and decoded before the current frames, the encoding and decoding order for frame “0”˜“8” are {0, 8, 4, 2, 1, 3, 6, 5, 7}.
It should be noticed that the frame “8” is the first frame of the next GOF, but it should be processed before the frame “1”˜“7”. And if the frame “8” was encoded or decoded in the current GOF, the processing for the frame “8” which is also the frame “0” in the next GOF should be skipped in the next GOF.
2) This embodiment describes an example of how to apply hierarchical coding accuracy for attribute inter prediction based on the coding priorities of the samples.
In the example, the point cloud frames in the point cloud sequence are divided in multiple GOFs and the GOF size is set to 8. As shown in FIG. 6, the hierarchical reference relationship is applied.
The hierarchical coding priorities are calculated based on the principle that the reference frame has higher coding priority than the current frame. The coding priorities results are shown in Table 2.

TABLE 2
Coding priority for each frame in one GOF

| | Frame time stamp | | | | | | | | |
|---|---|---|---|---|---|---|---|---|---|
| | 0 | 1 | 2 | 3 | 4 | 5 | 6 | 7 | 8 |
| Coding priority | 4 | 1 | 2 | 1 | 3 | 1 | 2 | 1 | 4 |

In the example, QP value is used to control the coding accuracy. The lower the QP value, the higher the coding accuracy. Thus, a hierarchical QP values structure is applied to frames so that the coding accuracy can be changes based on the coding priority.
For each frame, the QP value is calculated as below.

$$Q {P}_{r e a l} = Q {P}_{original} + QP\_shift$$

The QP_shift values for each frame are shown in Table 3.

TABLE 3
QP_shift value for each frame in one GOF

| | Frame time stamp | | | | | | | | |
|---|---|---|---|---|---|---|---|---|---|
| | 0 | 1 | 2 | 3 | 4 | 5 | 6 | 7 | 8 |
| QP_shift | 0 | +3step | +2step | +3step | +step | +3step | +2step | +3step | 0 |

The parameter step is one non-negative number that is used to control the change scale of the hierarchical QP value. In test, it can be 2/3/4, etc. al.
For example, when step is set to 3, the QP_shift values for each frame are shown in Table 4.

TABLE 4
QP_shift value for each frame in one GOF when step = 3

| | Frame time stamp | | | | | | | | |
|---|---|---|---|---|---|---|---|---|---|
| | 0 | 1 | 2 | 3 | 4 | 5 | 6 | 7 | 8 |
| QP_shift | 0 | +9 | +6 | +9 | +3 | +9 | +6 | +9 | 0 |

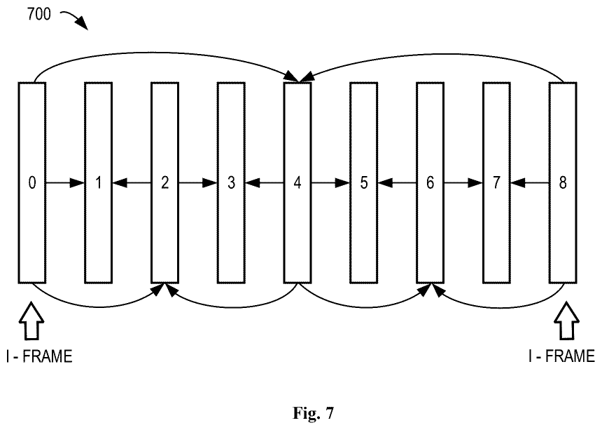

3) This embodiment describes an example of how to perform the geometry inter prediction with two reference frames when using octree geometry coding.
In this example, the geometry information is represented by an octree structure and the occupancy code of each node. As shown in FIG. 6, a hierarchical reference relationship is applied. For each frame, there are two reference frames which are used for geometry inter prediction.
At the encoder, the same octree division is performed on the current frame and the reference frames. Thus, the octree structures are the same for the current frame and the reference frames. A FIFO queue is used to store the nodes that need to be processed.
A bool flag predicted_forward is used for each node to indicate the source of the reference occupancy code:
   a. If the reference occupancy code is the occupancy code of the node in the reference frame with an earlier time stamp, predicted_forward is set to 1.
   b. If the reference occupancy code is the occupancy code of the node in the reference frame with a later time stamp, predicted_forward is set to 0.
A parameter mismatched_count_parent_node is used to indicate the number of mismatched bits between the occupancy code of the parent node and the reference occupancy code for parent node.
Firstly, the root node of the octree of the current node is generated and pushed into the queue. The predicted_forward value of the root node is set to 1. The mismatched_count_parent_node value of the root node is set to 0.
Secondly, Perform the following process until the queue is empty:
   a. Get the node at the header of the queue and its corresponding forward reference node and backward reference node. The forward reference node and the backward reference node are the nodes which share the same location in the octree structure as the current node in two reference frames. The first reference node is in the reference frame with an earlier time stamp, and the other reference node is in the reference frame with a later time stamp.
   b. Calculate the occupancy codes for the current node, the forward reference node and the backward reference node as OC_{current}, OC_{forward}, OC_{backward}.
   c. Count the numbers of mismatched bits between the current OC_{current} and OC_{forward} as mismatched_count_forward. Count the numbers of mismatched bits between the current OC_{current} and OC_{backward} as mismatched_count_backward.
   d. If the predicted_forward of current node is 1, the reference occupancy code, OC_{reference} is set to OC_{forward}; Otherwise, OC_{reference} is set to OC_{backward}.
   e. If the mismatched_count_parent_node is larger than 4, the OC_{reference} is set to all zero.
   f. Use OC_{reference} and the intra prediction results as the part of the contexts to perform the predictive coding for OC_{current}.
   g. If the current node can be divided into 8 child nodes, for each bit in OC_{current} and it correspond child node:
      i. If there is no point in the child node, skip it. Otherwise, move to next step.
      ii. Get the corresponding bits in OC_{forward} and OC_{backward}, as bit_0 and bit_1 respectively.
      iii. If bit_0=1 and bit_1=1, the predicted_forward value of the child node is set to 0 and the mismatched_count_parent_node value of the child node is set to mismatched_count_backward.
      iv. If bit_0=1 and bit_1=0, the predicted_forward value of the child node is set to 1 and the mismatched_count_parent_node value of the child node is set to mismatched_count_forward.
      v. If bit_0=0 and bit_1=0 or bit_0=1 and bit_1=1:
         (1) If mismatched_count_backward<mismatched_count_forward, the predicted_forward value of the child node is set to 0 and the mismatched_count_parent_node value of the child node is set to mismatched_count_backward.
         (2) If mismatched_count_backward>mismatched_count_forward, the predicted_forward value of the child node is set to 1 and the mismatched_count_parent_node value of the child node is set to mismatched_count_forward.
         (3) If mismatched_count_backward=mismatched_count_forward, the predicted_forward value of the child node is set to the predicted_forward value of the current node and the mismatched_count_parent_node value of the child node is set to mismatched_count_forward.
      vi. Push the child node into the queue.
   h. Pop the current node out of the queue.
At the decoder, the same process is performed on the current frame and the reference frames. Thus, the reference occupancy code can be derived for each node. The occupancy code can be decoded based on the reference occupancy code.
4) This embodiment describes an example of how to perform the geometry inter prediction with two reference frames when using octree geometry coding.
In this example, the geometry information is represented by an octree structure and the occupancy code of each node. As shown in FIG. 6, a hierarchical reference relationship is applied. For each frame, there are two reference frames which are used for geometry inter prediction.
At the encoder, the same octree division is performed on the current frame and the reference frames. Thus, the octree structures are the same for the current frame and the reference frames. A FIFO queue is used to store the nodes that need to be processed.
A bool flag predicted_forward is used for each node to indicate the source of the reference occupancy code:
   c. If the reference occupancy code is the occupancy code of the node in the reference frame with an earlier time stamp, predicted_forward is set to 1.
   d. If the reference occupancy code is the occupancy code of the node in the reference frame with a later time stamp, predicted_forward is set to 0.
A parameter mismatched_count_parent_node is used to indicate the number of mismatched bits between the occupancy code of the parent node and the reference occupancy code for parent node.
Firstly, the root node of the octree of the current node is generated and pushed into the queue. The predicted_forward value of the root node is set to 1. The mismatched_count_parent_node value of the root node is set to 0.
Secondly, Perform the following process until the queue is empty:
   i. Get the node at the header of the queue and its corresponding forward reference node and backward reference node. The forward reference node and the backward reference node are the nodes which share the same location in the octree structure as the current node in two reference frames. The first reference node is in the reference frame with an earlier time stamp, and the other reference node is in the reference frame with a later time stamp.
   j. Calculate the occupancy codes for the current node, the forward reference node and the backward reference node as OC_{current}, OC_{forward}, OC_{backward}.
   k. Count the numbers of mismatched bits between the current OC_{current} and OC_{forward} as mismatched_count_forward. Count the numbers of mismatched bits between the current OC_{current} and OC_{backward} as mismatched_count_backward.
   l. If the predicted_forward of current node is 1, the reference occupancy code, OC_{reference} is set to OC_{forward}; Otherwise, OC_{reference} is set to OC_{backward}.
   m. If the mismatched_count_parent_node is larger than 4, the OC_{reference} is set to all zero.
   n. Use OC_{reference} and the intra prediction results as the part of the contexts to perform the predictive coding for OC_{current}.
   o. If the current node can be divided into 8 child nodes, for each bit in OC_{current} and it correspond child node:
      i. If there is no point in the child node, skip it. Otherwise, move to next step.
      ii. Get the corresponding bits in OC_{forward} and OC_{backward}, as bit_0 and bit_1 respectively.
      iii. If bit_0=0 and bit_1=1, the predicted_forward value of the child node is set to 0 and the mismatched_count_parent_node value of the child node is set to mismatched_count_backward.
      iv. If bit_0=1 and bit_1=0, the predicted_forward value of the child node is set to 1 and the mismatched_count_parent_node value of the child node is set to mismatched_count_forward.
      v. If bit_0=0 and bit_1=0 or bit_0=1 and bit_1=1:
         (1) If mismatched_count_backward<mismatched_count_forward, the predicted_forward value of the child node is set to 0 and the mismatched_count_parent_node value of the child node is set to mismatched_count_backward.
         (2) If mismatched_count_backward>mismatched_count_forward, the predicted_forward value of the child node is set to 1 and the mismatched_count_parent_node value of the child node is set to mismatched_count_forward.
         (3) If mismatched_count_backward=mismatched_count_forward, the predicted_forward value of the child node is set to the predicted_forward value of the current node and the mismatched_count_parent_node value of the child node is set to mismatched_count_forward.
      vi. Push the child node into the queue.
   p. Pop the current node out of the queue.
At the decoder, the same process is performed on the current frame and the reference frames. Thus, the reference occupancy code can be derived for each node. The occupancy code can be decoded based on the reference occupancy code.
5) This embodiment describes an example of how to perform the attribute inter prediction with two reference frames.
In this example, the attribute information is represented by the reflection value of each point. As shown in FIG. 6, a hierarchical reference relationship is applied. For each frame, there are two reference frames which are used for attribute inter prediction.
At the encoder, 3 reference points, {point 0, point 1, point 2}, will be selected from the current frame and the reference frames. The predicted attribute value will be calculated based on the attribute values of the reference points. Then the residual between the predicted attribute value and the current attribute value will be calculated and signaled to the decoder.
For each point, an array neighbors is used to record the selected reference points with weight value. The weight value of each reference point is the distance between the reference point and the current point.
Firstly, the points in the current frame and the reference frames are reordered by motion code order.
Secondly, for each point, the encoder will search 3 reference points which are nearest to the current point. The search results and their weight values will be stored in neighbors:
   a. The reference point searching is performed on the current frame:
      i. Scan the coded points within the same motion code level.
      ii. Scan the coded points within a search range. The search range is defined by a parameter.
   b. The reference point searching is performed on the reference frames:
      iii. Scan the coded points within the same motion code level.
      iv. Scan the coded points within a search range. The search range is defined by a parameter.
Thirdly, the weight values of the reference points will be recomputed. The reference point from the current frame should have higher weight value.
Fourthly, the predicted attribute value will be selected from a candidate list:
   a. The weighted average of the attribute values of the reference points.
   b. Attribute value of the reference point 0.
   c. Attribute value of the reference point 1.
   d. Attribute value of the reference point 2.
For each candidate value, a coding score will be calculated based on the compression bits and prediction residual. Then the encoder will select the candidate value with the highest coding score. The indication referring to the selected candidate will be signaled to the decoder.
Finally, the residual between the attribute value and the predicted attribute value will be calculated and signaled to the decoder.
At the decoder, the reference points will be searched for each point by the same method as the encoding process.
The candidate list will be calculated in the same way and the indication will be decoded for each point to get the predicted attribute value. Based on that, the prediction residual will be decoded and the real attribute value will be generated.
6) This embodiment describes an example of how to perform the inter prediction for both geometry coding and attribute coding with two reference frames.
A hierarchical GOF structure is proposed to perform the inter prediction for geometry coding and attribute coding.
In the hierarchical GOF structure, the first frame in each GOF is an I-frame. The other frames in the GOF are B-frames, which means that the frame will use two reference frames from the forward and backward directions.
As shown in FIG. 7, the frame “0”˜“7” are the frames in one GOF and the frame “8” is the first frame of the next GOF.
For frame “0”˜“8”, the reference frames are shown in Table 5.

TABLE 5
Reference frames for each frame in one GOF

| | Frame time stamp | | | | | | | | |
|---|---|---|---|---|---|---|---|---|---|
| | 0 | 1 | 2 | 3 | 4 | 5 | 6 | 7 | 8 |
| Reference frame | None | 0, | 0, | 2, | 0, | 4, | 4, | 6, | None |
| time stamp | | 2 | 4 | 4 | 8 | 6 | 8 | 8 | |

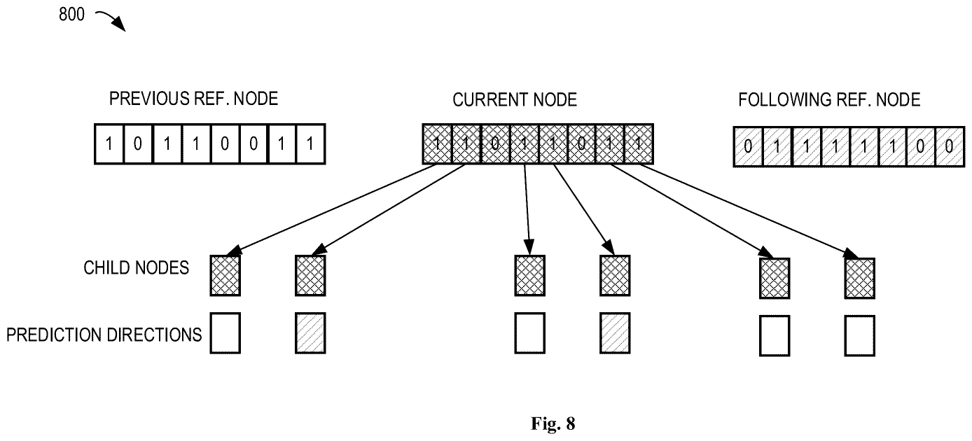

The encoding and decoding order for frame “0”˜“8” are {0, 8, 4, 2, 1, 3, 6, 5, 7}.
For geometry coding, the same octree division is performed on the current frame and the two reference frames.
For each node in octree, the occupancy codes of the current node and the reference nodes are calculated. As shown in FIG. 8, the prediction direction of the child nodes of the current node are derived based on the occupancy codes of the current node and the reference nodes.
For each child node of the current node, the corresponding bit values in the occupancy codes of the reference nodes are denoted as bit_pre and bit_follow:
If bit_pre=1 and bit_follow=0, the prediction direction of the child node is set to using the previous reference (forward) node to perform inter prediction.
If bit_pre=0 and bit_follow=1, the prediction direction of the child node is set to using the following reference (backward) node to perform inter prediction.
If bit_pre=bit_follow, the numbers of the mismatched bits between the occupancy code of current node and the occupancy codes of the reference nodes are calculated.
If the numbers of the mismatched bits are different, the prediction direction of the child node is set to the prediction direction with less mismatched number. Otherwise, the prediction direction of the child node is set to the prediction direction of the current node.
When coding the attribute, three reference points, {point 0, point 1, point 2}, are selected from the current frame and the two reference frames. The predicted attribute value will be calculated based on the attribute values of the reference points, which is similar with the Inter-EM.
Besides, a hierarchical QP structure is applied to perform the attribute coding. There is a QP_{shift} value for each frame based on the reference relationship. The QP_{shift} value for reference frame should be lower than that of the current frame.
For each frame, the real attribute QP value is set to:

$$Q {P}_{original} + Q {P}_{s h i f t} .$$

The quantization process is performed based on the real attribute QP value.
7) This embodiment describes an example of how to perform the inter prediction for both geometry coding and attribute coding with merging the two reference frames.
A hierarchical GOF structure is proposed to perform the inter prediction for geometry coding and attribute coding.
In the hierarchical GOF structure, the first frame in each GOF is an I-frame. The other frames in the GOF are B-frames, which means that the frame will use two reference frames from the forward and backward directions.
As shown in FIG. 7, the frame “0”˜“7” are the frames in one GOF and the frame “8” is the first frame of the next GOF.
For frame “0”˜“8”, the reference frames are shown in Table 5. The encoding and decoding order for frame “0”˜“8” is {0, 8, 4, 2, 1, 3, 6, 5, 7}.
For each frame, global motions are firstly applied to the two reference frames. And then all points in two reference frames are merged into one new merged reference frame.
For geometry coding, the same octree division is performed on the current frame and the merged reference frame. Then the geometry inter prediction is performed on the current frame and the merged reference frame.
When coding the attribute, three reference points, {point 0, point 1, point 2}, are selected from the current frame and the merged reference frame. The predicted attribute value will be calculated based on the attribute values of the reference points, which is similar with the Inter-EM.
Besides, a hierarchical QP structure is applied to perform the attribute coding. There is a QP_{shift} value for each frame based on the reference relationship. The QP_{shift} value for reference frame should be lower than that of the current frame.
For each frame, the real attribute QP value is set to:

$$Q {P}_{original} + Q {P}_{s h i f t} .$$

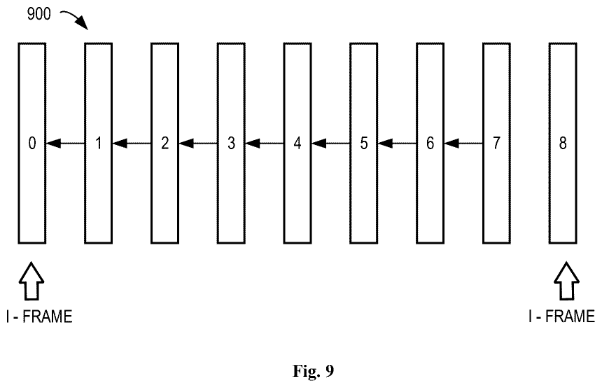

The quantization process is performed based on the real attribute QP value.
8) This embodiment describes an example of how to decide which GOF structure to be applied to one GOF.
The example of one IBBB GOF structure is shown in FIG. 7, there are two reference frames for each frame except the first frame in one GOF.
The example of one IPPP GOF structure is shown in FIG. 9, there are one reference frame for each frame except the first frame in one GOF. frame 8 is the first frame in the next GOF.
At the encoder, for each GOF, the frame 0 is firstly processed. The frame 0 is encoded or decoded if the GOF is the first GOF in one point cloud sequence. Otherwise, the frame 0 is skipped because it is already encoded or decoded when processing the previous one GOF.
Then the frame 8 is processed and the motion information between frame 0 and frame 8 is derived. The rotation degrees (Rx, Ry, Rz) and translation vector (Sx, Sy, Sz) are derived based on the motion information.
If the motion information meets two conditions, the IBBB GOF structure is applied to the GOF. Otherwise, the IPPP GOF structure is applied to the GOF.
   (1) All of the rotation degrees are less than thr1:

$$t h r 1 = 0 \text{.1} * random\_access \_period$$

where random_access_period is the parameter to indicate the least frame distance between two I-frames.
   (2) The translation vector is less than thr2:

$$thr 2 = 0.005 * ( 2 * quantization\_bits + 1 ) * slice\_size$$

where quantization_bits is the parameter to indicate the geometry quantization scale, slice_size is the parameter to indicate the bounding box size of frame 8.
There is one signal change_GOF_structure to indicate the GOF structure selection result and the signal is to be signaled to the decoder. If the IBBB GOF structure is applied, change_GOF_structure is set to 0.
Otherwise, change_GOF_structure is set to 1.
At the decoder, the IBBB GOF structure is firstly applied to each GOF. Only If change_GOF_structure is equal to 1, the IPPP GOF structure is applied in the decoding process of the GOF.

More details of the embodiments of the present disclosure will be described below which are related to multi-reference inter prediction for point cloud coding. The embodiments of the present disclosure should be considered as examples to explain the general concepts and should not be interpreted in a narrow way. Furthermore, these embodiments can be applied individually or combined in any manner.

As used herein, the term “point cloud sequence” may refer to a sequence of one or more point clouds. The term “point cloud frame” or “frame” may refer to a point cloud in a point cloud sequence. The term “point cloud (PC) sample” may refer to a frame, a picture, a slice, a tile, a subpicture, a node, a point, or a unit containing one or more nodes or points.

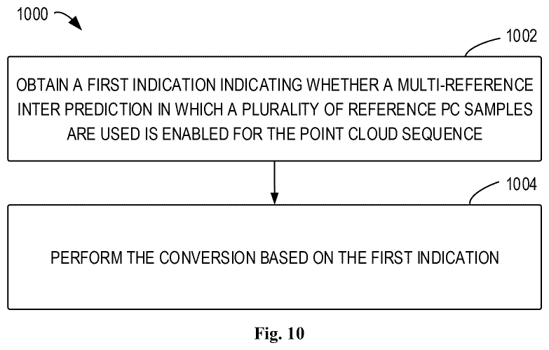

FIG. 10 illustrates a flowchart of a method 1000 for point cloud coding in accordance with some embodiments of the present disclosure. The method 1000 may be implemented during a conversion between a current PC sample of a point cloud sequence and a bitstream of the point cloud sequence. As shown in FIG. 10, the method 1000 starts at 1002, where a first indication indicating whether a multi-reference inter prediction in which a plurality of reference PC samples are used is enabled for the point cloud sequence is obtained. By way of example rather than limitation, if the multi-reference inter prediction is used for a PC sample, a plurality of reference PC samples may be used for coding the PC sample. With reference to FIG. 7, the 1st frame and 8th frame is used as reference frames for the 4th frame.

In some embodiments, the first indication may be determined at an encoder and comprised in the bitstream. At a decoder, the first indication may be obtained from the bitstream. By way of example rather than limitation, the first indication may be a syntax element, an index, a flag, or the like. It should be noted that the first indication may be implemented as a single indication, a plurality of indications or a combination of the plurality of indications. In one example, the first indication may be coded with fixed-length coding. In another example, the first indication may be coded with unary coding. In a further example, the first indication may be coded with truncated unary coding. Alternatively, the first indication may be coded in a predictive way. It should be understood that the above illustrations and/or examples are described merely for purpose of description. The scope of the present disclosure is not limited in this respect.

At 1004, the conversion is performed based on the first indication. In some embodiments the conversion may include encoding the current PC sample into the bitstream. Alternatively or additionally, the conversion may include decoding the current PC sample from the bitstream.

In view of the foregoing, the conversion between the point cloud sequence and the bitstream is performed based on an indication indicating whether the multi-reference inter prediction is enabled for the point cloud sequence. Thereby, the proposed method can advantageously better support the usage of multi-reference inter prediction and facilitate the application of multi-reference inter prediction, and thus the coding quality of point cloud coding can be improved.

In some embodiments, if the first indication indicates the multi-reference inter prediction is disable for the point cloud sequence, a single reference PC sample may be allowed to be used for performing an inter prediction on the current PC sample. That is, at most one reference PC sample is allowed to be used for performing an inter prediction on the current PC sample. Alternatively, the current PC sample may be coded based on any other prediction process other than inter prediction, such as intra prediction.

In some embodiments, at 1004, a second indication indicating whether the multi-reference inter prediction is used for the current PC sample may be obtained. Moreover, the conversion may be performed based on the first indication and the second indication. By way of example rather than limitation, if the first indication indicates that the multi-reference inter prediction is enable for the point cloud sequence and the second indication indicates that the multi-reference inter prediction is used for the current PC sample, the current PC sample may be coded based on the multi-reference inter prediction by using a plurality of reference PC samples.

In some embodiments, the second indication may be determined at an encoder and comprised in the bitstream. At a decoder, the second indication may be obtained from the bitstream. By way of example rather than limitation, the second indication may be a syntax element, an index, a flag, or the like. It should be noted that the second indication may be implemented as a single indication, a plurality of indications or a combination of the plurality of indications. In one example, the second indication may be coded with fixed-length coding. In another example, the second indication may be coded with unary coding. In a further example, the second indication may be coded with truncated unary coding. Alternatively, the second indication may be coded in a predictive way. It should be understood that the above illustrations and/or examples are described merely for purpose of description. The scope of the present disclosure is not limited in this respect.

In some alternative embodiments, the second indication may be determined at a decoder. In one example, the second indication may be determined based on global motion information, reference structure or the like.

In some embodiments, the point cloud sequence may comprise a plurality of PC samples. A position of the current PC sample in a time stamp order of the plurality of PC samples may be comprised in the bitstream. By way of example rather than limitation, the time stamp order may be in a form of continuously increasing integer numbers. In one example, the position may be coded with fixed-length coding. In another example, the position may be coded with unary coding. In a further example, the position may be coded with truncated unary coding. Alternatively, the position may be coded in a predictive way. It should be understood that the above illustrations and/or examples are described merely for purpose of description. The scope of the present disclosure is not limited in this respect.

In some alternative embodiments, a third indication indicating a position of the current PC sample in a time stamp order of the plurality of PC samples may be comprised in the bitstream. For example, the position may be indirectly signaled to the decoder. By way of example rather than limitation, the plurality of PC samples may comprise a further PC sample different from the current PC sample, and the third indication may comprise an offset dependent on the position of the current PC sample and a position of the further PC sample in the time stamp order.

In some embodiments, the further PC sample may precede the current PC sample in a coding order of the plurality of PC samples. The coding order may be different from the time stamp order. Alternatively, the further PC sample may immediately precede the current PC sample in the coding order.

In some alternative embodiments, the further PC sample may immediately precede the current PC sample in a set of PC samples of the point cloud sequence that satisfy one or more specific conditions. In one example, each of the set of PC samples satisfies one of the following conditions: an inter prediction is disabled for the respective PC sample, or the respective PC sample is coded based on an inter prediction using a single reference PC sample. In another example, an inter prediction is disabled for each of the set of PC samples. In a further example, each of the set of PC samples is coded based on an inter prediction using a single reference PC sample.

It should be noted that the current PC sample may be comprised in the set of PC samples or may be excluded from the set of PC samples. The further PC sample may be one of the set of PC samples that immediately precede the current PC sample in coding order. It should be understood that the above illustrations and/or examples are described merely for purpose of description. The scope of the present disclosure is not limited in this respect.

In some embodiments, the offset may be determined at an encoder based on the position of the current PC sample and the position of the further PC sample. By way of example rather than limitation, the offset may be determined as a difference between the position of the current PC sample and the position of the further PC sample. Accordingly, the position of the current PC sample may be determined at a decoder based on the offset.

By way of example rather than limitation, the third indication may be a syntax element, an index, a flag, or the like. It should be noted that the third indication may be implemented as a single indication, a plurality of indications or a combination of the plurality of indications. In one example, the third indication may be coded with fixed-length coding. In another example, the third indication may be coded with unary coding. In a further example, the third indication may be coded with truncated unary coding. Alternatively, the third indication may be coded in a predictive way. It should be understood that the above illustrations and/or examples are described merely for purpose of description. The scope of the present disclosure is not limited in this respect.

According to further embodiments of the present disclosure, a non-transitory computer-readable recording medium is provided. The non-transitory computer-readable recording medium stores a bitstream of a point cloud sequence which is generated by a method performed by an apparatus for point cloud coding. In the method, a first indication indicating whether a multi-reference inter prediction in which a plurality of reference PC samples are used is enabled for the point cloud sequence is obtained. Moreover, the bitstream is generated based on the first indication.

According to still further embodiments of the present disclosure, a method for storing a bitstream of a point cloud sequence is provided. According to the method, a first indication indicating whether a multi-reference inter prediction in which a plurality of reference PC samples are used is enabled for the point cloud sequence is obtained. Moreover, the bitstream is generated based on the first indication, and the bitstream is stored in a non-transitory computer-readable recording medium.

Implementations of the present disclosure can be described in view of the following clauses, the features of which can be combined in any reasonable manner.

Clause 1. A method for point cloud coding, comprising: obtaining, for a conversion between a current point cloud (PC) sample of a point cloud sequence and a bitstream of the point cloud sequence, a first indication indicating whether a multi-reference inter prediction in which a plurality of reference PC samples are used is enabled for the point cloud sequence; and performing the conversion based on the first indication.

Clause 2. The method of clause 1, wherein the first indication is comprised in the bitstream.

Clause 3. The method of any of clauses 1-2, wherein the first indication is coded with one of the following: fixed-length coding, unary coding, or truncated unary coding.

Clause 4. The method of any of clauses 1-2, wherein the first indication is coded in a predictive way.

Clause 5. The method of any of clauses 1-4, wherein if the first indication indicates the multi-reference inter prediction is disable for the point cloud sequence, a single reference PC sample is allowed to be used for performing an inter prediction on the current PC sample.

Clause 6. The method of any of clauses 1-5, wherein performing the conversion comprises: obtaining a second indication indicating whether the multi-reference inter prediction is used for the current PC sample; and performing the conversion based on the first indication and the second indication.

Clause 7. The method of clause 6, wherein the second indication is determined at an encoder and comprised in the bitstream.

Clause 8. The method of any of clauses 6-7, wherein the second indication is coded with one of the following: fixed-length coding, unary coding, or truncated unary coding.

Clause 9. The method of any of clauses 6-7, wherein the second indication is coded in a predictive way.

Clause 10. The method of clause 6, wherein the second indication is determined at a decoder.

Clause 11. The method of any of clauses 1-10, wherein the point cloud sequence comprises a plurality of PC samples, and a position of the current PC sample in a time stamp order of the plurality of PC samples is comprised in the bitstream.

Clause 12. The method of clause 11, wherein the position is coded with one of the following: fixed-length coding, unary coding, or truncated unary coding.

Clause 13. The method of clause 11, wherein the position is coded in a predictive way.

Clause 14. The method of any of clauses 1-10, wherein the point cloud sequence comprises a plurality of PC samples, and a third indication indicating a position of the current PC sample in a time stamp order of the plurality of PC samples is comprised in the bitstream.

Clause 15. The method of clause 14, wherein the plurality of PC samples comprises a further PC sample different from the current PC sample, and the third indication comprises an offset dependent on the position of the current PC sample and a position of the further PC sample in the time stamp order.

Clause 16. The method of clause 15, wherein the further PC sample precedes the current PC sample in a coding order of the plurality of PC samples.

Clause 17. The method of clause 15, wherein the further PC sample immediately precedes the current PC sample in a coding order of the plurality of PC samples.

Clause 18. The method of clause 15, wherein the further PC sample immediately precedes the current PC sample in a set of PC samples of the point cloud sequence, and each of the set of PC samples satisfies one of the following conditions: an inter prediction is disabled for the respective PC sample, or the respective PC sample is coded based on an inter prediction using a single reference PC sample.

Clause 19. The method of clause 15, wherein the further PC sample immediately precedes the current PC sample in a set of PC samples of the point cloud sequence, and an inter prediction is disabled for each of the set of PC samples.

Clause 20. The method of clause 15, wherein the further PC sample immediately precedes the current PC sample in a set of PC samples of the point cloud sequence, and each of the set of PC samples is coded based on an inter prediction using a single reference PC sample.

Clause 21. The method of any of clauses 15-20, wherein the offset is determined at an encoder based on the position of the current PC sample and the position of the further PC sample.

Clause 22. The method of any of clauses 15-21, wherein the position of the current PC sample is determined at a decoder based on the offset.

Clause 23. The method of any of clauses 14-22, wherein the third indication is coded with one of the following: fixed-length coding, unary coding, or truncated unary coding.

Clause 24. The method of any of clauses 14-22, wherein the third indication is coded in a predictive way.

Clause 25. The method of any of clauses 11-24, wherein the time stamp order is different from a coding order of the plurality of PC samples.

Clause 26. The method of any of clauses 11-25, wherein the time stamp order is in a form of continuously increasing integer numbers.

Clause 27. The method of any of clauses 1-26, wherein a PC sample is one of the following: a frame, a picture, a slice, a tile, a subpicture, a node, a point, or a unit containing one or more nodes or points.

Clause 28. The method of any of clauses 1-27, wherein the conversion includes encoding the current PC sample into the bitstream.

Clause 29. The method of any of clauses 1-27, wherein the conversion includes decoding the current PC sample from the bitstream.

Clause 30. An apparatus for point cloud coding comprising a processor and a non-transitory memory with instructions thereon, wherein the instructions upon execution by the processor, cause the processor to perform a method in accordance with any of clauses 1-29.

Clause 31. A non-transitory computer-readable storage medium storing instructions that cause a processor to perform a method in accordance with any of clauses 1-29.

Clause 32. A non-transitory computer-readable recording medium storing a bitstream of a point cloud sequence which is generated by a method performed by an apparatus for point cloud coding, wherein the method comprises: obtaining a first indication indicating whether a multi-reference inter prediction in which a plurality of reference PC samples are used is enabled for the point cloud sequence; and generating the bitstream based on the first indication.

Clause 33. A method for storing a bitstream of a point cloud sequence, comprising: obtaining a first indication indicating whether a multi-reference inter prediction in which a plurality of reference PC samples are used is enabled for the point cloud sequence; generating the bitstream based on the first indication; and storing the bitstream in a non-transitory computer-readable recording medium.

### Example Device

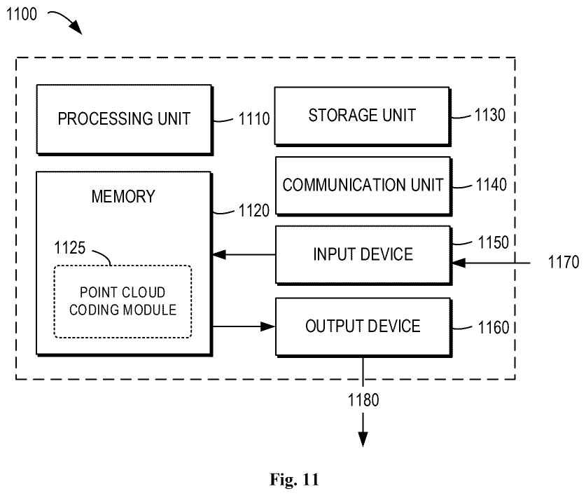

FIG. 11 illustrates a block diagram of a computing device 1100 in which various embodiments of the present disclosure can be implemented. The computing device 1100 may be implemented as or included in the source device 110 (or the GPCC encoder 116 or 200) or the destination device 120 (or the GPCC decoder 126 or 300).

It would be appreciated that the computing device 1100 shown in FIG. 11 is merely for purpose of illustration, without suggesting any limitation to the functions and scopes of the embodiments of the present disclosure in any manner.

As shown in FIG. 11, the computing device 1100 includes a general-purpose computing device 1100. The computing device 1100 may at least comprise one or more processors or processing units 1110, a memory 1120, a storage unit 1130, one or more communication units 1140, one or more input devices 1150, and one or more output devices 1160.

In some embodiments, the computing device 1100 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1100 can support any type of interface to a user (such as “wearable” circuitry and the like).

The processing unit 1110 may be a physical or virtual processor and can implement various processes based on programs stored in the memory 1120. In a multi-processor system, multiple processing units execute computer executable instructions in parallel so as to improve the parallel processing capability of the computing device 1100. The processing unit 1110 may also be referred to as a central processing unit (CPU), a microprocessor, a controller or a microcontroller.

The computing device 1100 typically includes various computer storage medium. Such medium can be any medium accessible by the computing device 1100, including, but not limited to, volatile and non-volatile medium, or detachable and non-detachable medium. The memory 1120 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1130 may be any detachable or non-detachable medium and may include a machine-readable medium such as a memory, flash memory drive, magnetic disk or another other media, which can be used for storing information and/or data and can be accessed in the computing device 1100.

The computing device 1100 may further include additional detachable/non-detachable, volatile/non-volatile memory medium. Although not shown in FIG. 11, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1140 communicates with a further computing device via the communication medium. In addition, the functions of the components in the computing device 1100 can be implemented by a single computing cluster or multiple computing machines that can communicate via communication connections. Therefore, the computing device 1100 can operate in a networked environment using a logical connection with one or more other servers, networked personal computers (PCs) or further general network nodes.

The input device 1150 may be one or more of a variety of input devices, such as a mouse, keyboard, tracking ball, voice-input device, and the like. The output device 1160 may be one or more of a variety of output devices, such as a display, loudspeaker, printer, and the like. By means of the communication unit 1140, the computing device 1100 can further communicate with one or more external devices (not shown) such as the storage devices and display device, with one or more devices enabling the user to interact with the computing device 1100, or any devices (such as a network card, a modem and the like) enabling the computing device 1100 to communicate with one or more other computing devices, if required. Such communication can be performed via input/output (I/O) interfaces (not shown).

In some embodiments, instead of being integrated in a single device, some or all components of the computing device 1100 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1100 may be used to implement point cloud encoding/decoding in embodiments of the present disclosure. The memory 1120 may include one or more point cloud coding modules 1125 having one or more program instructions. These modules are accessible and executable by the processing unit 1110 to perform the functionalities of the various embodiments described herein.

In the example embodiments of performing point cloud encoding, the input device 1150 may receive point cloud data as an input 1170 to be encoded. The point cloud data may be processed, for example, by the point cloud coding module 1125, to generate an encoded bitstream. The encoded bitstream may be provided via the output device 1160 as an output 1180.

In the example embodiments of performing point cloud decoding, the input device 1150 may receive an encoded bitstream as the input 1170. The encoded bitstream may be processed, for example, by the point cloud coding module 1125, to generate decoded point cloud data. The decoded point cloud data may be provided via the output device 1160 as the output 1180.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for point cloud coding, comprising:
obtaining, for a conversion between a current point cloud (PC) sample of a point cloud sequence and a bitstream of the point cloud sequence, a first indication indicating whether a multi-reference inter prediction in which a plurality of reference PC samples are used is enabled for the point cloud sequence; and
performing the conversion based on the first indication.

2. The method of claim 1, wherein the first indication is comprised in the bitstream.

3. The method of claim 1, wherein the first indication is coded with a scheme different from fixed-length coding, unary coding, and truncated unary coding.

4. The method of claim 1, wherein if the first indication indicates that the multi-reference inter prediction is disable for the point cloud sequence, a single reference PC sample is allowed to be used for performing an inter prediction on the current PC sample.

5. The method of claim 1, wherein performing the conversion comprises:
obtaining a second indication indicating whether the multi-reference inter prediction is used for the current PC sample; and
performing the conversion based on the second indication.

6. The method of claim 5, wherein the second indication is comprised in the bitstream.

7. The method of claim 5, wherein the second indication is coded with fixed-length coding.

8. The method of claim 5, wherein the second indication is determined at a decoder.

9. The method of claim 1, wherein the multi-reference inter prediction is bi-prediction.

10. The method of claim 1, wherein the current PC sample is a slice.

11. The method of claim 1, wherein the point cloud sequence comprises a plurality of PC samples, and a position of the current PC sample in a time stamp order of the plurality of PC samples is comprised in the bitstream.

12. The method of claim 11, wherein the position is coded with one of the following: fixed-length coding, unary coding, or truncated unary coding, or
wherein the position is coded in a predictive way.

13. The method of claim 1, wherein the point cloud sequence comprises a plurality of PC samples, and a third indication indicating a position of the current PC sample in a time stamp order of the plurality of PC samples is comprised in the bitstream.

14. The method of claim 13, wherein the plurality of PC samples comprises a further PC sample different from the current PC sample, and the third indication comprises an offset dependent on the position of the current PC sample and a position of the further PC sample in the time stamp order.

15. The method of claim 14, wherein the further PC sample precedes the current PC sample in a coding order of the plurality of PC samples, or
wherein the further PC sample immediately precedes the current PC sample in a coding order of the plurality of PC samples, or
wherein the further PC sample immediately precedes the current PC sample in a set of PC samples of the point cloud sequence, and each of the set of PC samples satisfies one of the following conditions: an inter prediction is disabled for the respective PC sample, or the respective PC sample is coded based on an inter prediction using a single reference PC sample, or
wherein the further PC sample immediately precedes the current PC sample in a set of PC samples of the point cloud sequence, and an inter prediction is disabled for each of the set of PC samples, or
wherein the further PC sample immediately precedes the current PC sample in a set of PC samples of the point cloud sequence, and each of the set of PC samples is coded based on an inter prediction using a single reference PC sample, or
wherein the offset is determined at an encoder based on the position of the current PC sample and the position of the further PC sample, or
wherein the position of the current PC sample is determined at a decoder based on the offset.

16. The method of claim 11, wherein the time stamp order is different from a coding order of the plurality of PC samples, or
wherein the time stamp order is in a form of continuously increasing integer numbers.

17. The method of claim 1, wherein the conversion includes encoding the current PC sample into the bitstream, or
wherein the conversion includes decoding the current PC sample from the bitstream.

18. An apparatus for point cloud coding comprising a processor and a non-transitory memory with instructions thereon, wherein the instructions upon execution by the processor, cause the processor to perform acts comprising:
obtaining, for a conversion between a current point cloud (PC) sample of a point cloud sequence and a bitstream of the point cloud sequence, a first indication indicating whether a multi-reference inter prediction in which a plurality of reference PC samples are used is enabled for the point cloud sequence; and
performing the conversion based on the first indication.

19. A non-transitory computer-readable storage medium storing instructions that cause a processor to perform acts comprising:
obtaining, for a conversion between a current point cloud (PC) sample of a point cloud sequence and a bitstream of the point cloud sequence, a first indication indicating whether a multi-reference inter prediction in which a plurality of reference PC samples are used is enabled for the point cloud sequence; and
performing the conversion based on the first indication.

20. A non-transitory computer-readable recording medium storing a bitstream of a point cloud sequence which is generated by a method performed by an apparatus for point cloud coding, wherein the method comprises:
obtaining a first indication indicating whether a multi-reference inter prediction in which a plurality of reference PC samples are used is enabled for the point cloud sequence; and
generating the bitstream based on the first indication.
